(19) United States
(12) Patent Application Publication
(10) Pub. No.: US 2005/0157816 A1
(43) Pub. Date: Jul. 21, 2005

(54) Circuit and method for binary modulation

(75) Inventors: Naohiro Matsui, Kawasaki-shi (JP); Tatsuya Nakagawa, Ohtsu-shi (JP)

Correspondence Address: YOUNG & THOMPSON, 745 SOUTH 23RD STREET, 2ND FLOOR, ARLINGTON, VA, 22202, US

(73) Assignee: NEC COMPOUND SEMICONDUCTOR DEVICES, LTD., KAWASAKI-SHI (JP)

(21) Appl. No.: 11/038,162

(22) Filed: Jan. 21, 2005

(30) Foreign Application Priority Data
Jan. 21, 2004 (JP) 013733/2004

(51) Int. Cl. H04L 27/12

(52) U.S. Cl. 375/303; 332/100

(57) ABSTRACT

A binary FSK modulator circuit is composed of a signal mapping circuit, a D/A converter circuit, and a quadrature modulator circuit. The signal mapping circuit generates I data and Q data through signal mapping in response to an input bit stream, the I data being representative of an I channel projection and the Q data being representative of a Q channel projection. The D/A converter circuit develops an I-channel signal and a Q-channel signal through implementing D/A conversion on the I data and the Q data, respectively. The quadrature modulator circuit develops a resultant FSK-modulated signal through quadrature modulation of the I-channel signal and the Q-channel signal on a carrier signal.

### BACKGROUND OF THE INVENTION

1. Field of the Invention

The present invention generally relates to binary FSK (Frequency Shift Keying) modulation. More specifically, the present invention addresses stabilization of the center frequency and modulation index of the FSK-modulated signal.

2. Description of the Related Art

Great progress in recent digital techniques provide various modulation techniques employing digital signal processing and quadrature modulation for generating various sorts of modulated signals; however, there are not many techniques that use quadrature modulation for producing FSK-modulated signals. For instance, a conventional FSK modulation system disclosed in “Microwave & RF Circuit Design for Wireless Communications” written by Lawrence E. Larson, Artech House publisher, in 1997, pages 166 to 172 achieves FSK modulation through directly applying an NRZ (Non Return to Zero) bitstream signal to a voltage-controlled oscillator (VCO) as a VCO control voltage for generating an FSK-modulated signal.

FIGS. 1A and 1B illustrate the structure of the conventional FSK modulator circuit; FIG. 1A is a schematic functional block diagram of this conventional FSK modulator circuit, and FIG. 1B is a diagram representing a detailed arrangement of the FSK modulator circuit which contains a PLL (Phase-Locked Loop) circuit. FIG. 2 illustrates waveforms of an input bitstream signal and the corresponding FSK-modulated signal.

As illustrated in FIG. 1A, the FSK modulator circuit incorporates a VCO 300, and receives a bitstream signal 400 on a VCO control input of the VCO 300. The FSK modulator circuit uses the bitstream signal 400 as a control voltage for controlling the VCO 300. When the bitstream signal 400 represents a bit sequence of “100110”, for example, the FSK modulator circuit generates an FSK-modulated signal, the frequency of which varies in response to the value of each bit of the input bitstream signal 400, as illustrated in FIGS. 2A and 2b.

Generally speaking, as illustrated in FIG. 1B, a typical FSK modulator circuit incorporates a feedback loop containing a VCO 300 and a PLL circuit 301, and a switch circuit 302 inserted in the feedback loop for cutting off the feedback loop.

When FSK modulating is not implemented, the switch circuit 302 is turned on, and a VCO output signal outputted from the VCO 300 is provided for the PLL circuit 301. The PLL circuit 301 generates a control voltage signal in response the VCO output signal, and the control voltage signal is fed back to the control input of the VCO 300. This allows the VCO 300 to develop the VCO output signal so that the VCO output signal has a constant frequency. A loop filter 303, which is inserted between the switch circuit 302 and the input of the VCO 300, removes a high frequency component from the VCO control voltage, and thereby stabilizes the operation of the VCO 300.

When the FSK modulator circuit implements the FSK modulating, on the other hand, the switch circuit 302 is opened in response to a loop cutting off control signal. Additionally, the bitstream signal is applied as the control voltage of the VCO 300, and the oscillating frequency of the VCO 300 is controlled in response to the value of each bit of the bitstream signal.

This results in that the instantaneous frequency of the VCO output signal is switched between a relatively high frequency and a relatively low frequency as indicated in FIG. 2 for the bitstream signal representative of the bitstream of “100110”, and thereby an FSK-modulated signal is obtained.

The FSK modulator circuit, however, experiences instability of the frequency of the VCO output signal when performing FSK modulating, due to the open loop architecture. When the FSK modulating operation is carried out, the VCO 300 is controlled through open-loop control; the PLL circuit 301 provides no frequency control of the VCO 300. Accordingly, the center frequency of the FSK-modulated signal is shifted. This causes several problems including a frequency drift of the FSK-modulated signal, and instability of FSK modulation index, resulting from the non-linear characteristic of the modulation sensitivity of the VCO 300.

Placing the VCO 300 into the open loop control additional causes another problem that the oscillating frequency of the VCO becomes unstable, and thus, the frequency drift can be hardly controlled, because of a change in the amount of accumulated electric charges in the loop filter 303, inserted in the input of the VCO 300.

The following is a description of other conventional FSK modulation techniques. Japanese Laid-open Patent Application No. H08-37545 discloses an FSK modulator circuit which addresses externally adjusting the frequency offset from the center frequency within the FSK-modulated signal. The FSK modulator circuit is composed of a phase generating circuit, a multiplier circuit, a coefficient designating means, a phase integrating circuit, an I/Q signal generator circuit, and a quadrature modulator circuit. The phase generating circuit outputs a phase signal that indicates the phase value in response to the data value of the inputted digital data signal. The multiplying circuit multiples the phase value of the phase signal by a coefficient “K.” The coefficient designating means designates the coefficient “K” used in the multiplying circuit in response to an external instruction. The phase integrating circuit integrates the phase components of the output signal from the multiplying circuit to output an integrated phase signal. The I/Q signal generating circuit outputs a pair of signals, one being representative of the cosine value of the phase value and the other being representative of the sine value of the phase value which is indicated by the integrated phase signal of the phase integrating circuit as the I baseband signal and the Q baseband signal. The quadrature modulator circuit implements quadrature modulation on the respective baseband signals outputted from the I/Q signal generating circuit so as to output the FSK-modulated wave signal. Additionally, Japanese Laid-open Patent Application No. 2001-285378 discloses a similar digital modulator circuit that is designed to switch signal mapping processes for achieving different FSK modulations. More specifically, this digital modulator circuit is designed so that the modulation index and the number of data bits used for determining the frequency offset of the FSK-modulated signal are both adjustable.

Nevertheless, these FSK modulator circuits suffer from complexity in the hardware implementation.

Japanese Laid-open Patent Application No. 2002-190839 discloses a GFSK (Gaussian Frequency Shift Keying) modulation technique that addresses accurately generating a GFSK-modulated signal with a simple hardware implementation. The disclosed hardware implementation includes a buffer, a Mod2N calculating circuit, a ROM address setting circuit, a pair of ROMs, a pair of D/A converters, a pair of multipliers, and an adder. The buffer receives an input digital signal. The output signal from the buffer is provided for the Mod2N calculating circuit. The ROM address setting circuit sets the addresses of the data to be stored in the ROMs by employing the output of the Mod2N calculating circuit and the output signal of the buffer. The ROMs store thereinto the I-channel signal and the Q-channel signal. The I-channel signal and the Q-channel signal outputted from these ROMs are applied to the two D/A converters. The two multipliers multiply the signals outputted from the respective D/A converters by two carrier waves, the phases of which are different from each other by 90 degrees. The adder adds the output signals from the two multipliers to generate a resultant GFSK-modulated signal.

The above-described GFSK modulator circuit experiences a problem that the large-scaled memory is required.

Other similar digital modulation techniques are known in Japanese Laid-open Patent Applications Nos. H11-17759, and 2002-199034; however, these digital modulation techniques are not directed to FSK modulation. Japanese Laid-open Patent Application No. H11-17759 discloses a QAM (Quadrature Amplitude Modulation) technique based on digital processing. Japanese Laid-open Patent Applications No. 2002-199034 discloses a digital modulator incorporating a pre-distorter for compensating the non-linear distortion within the modulated signal; however, no description is given as to the kind of digital modulation.

### SUMMARY OF THE INVENTION

Therefore, an object of the present invention is to provide a binary FSK-modulation technique for achieving improved stability of the center frequency with a simple hardware implementation.

Another object of the present invention is to provide a binary FSK-modulation technique for achieving improved stability of the modulation index with simple architecture.

In an aspect of the present invention, a binary FSK modulator circuit is composed of: a signal mapping circuit generating I data and Q data through signal mapping in response to an input bitstream, the I data being representative of an I channel projection and the Q data being representative of a Q channel projection; a D/A converter circuit developing an I-channel signal and a Q-channel signal through implementing D/A conversion on the I data and the Q data, respectively; and a quadrature modulator circuit developing a resultant FSK-modulated signal through quadrature modulation of the I-channel signal and the Q-channel signal on a carrier signal.

Preferably, the binary FSK modulator circuit additionally includes a filter circuit filtering the I-channel signal and the Q-channel signal. In this case, the quadrature modulator circuit provides the quadrature modulation for the filtered I-channel and Q-channel signals. In a preferred embodiment, the filter circuit provides Gaussian filtering for the I-channel signal and the Q-channel signal.

In another aspect of the present invention, a method for generating an FSK-modulated signal is composed of:
generating I data and Q data through signal mapping in response to an input bitstream, the I data being representative of an I channel projection and the Q data being representative of a Q channel projection;
developing an I-channel signal and a Q-channel signal through implementing D/A conversion on the I data and the Q data, respectively; and
developing a resultant FSK-modulated signal through quadrature modulation of the I-channel signal and the Q-channel signal on a carrier signal.

### BRIEF DESCRIPTION OF THE DRAWINGS

These and other features, aspects, and advantages of the apparatus and methods of the present invention will become better understood with regard to the following description, appended claims, and accompanying drawings in which:

FIG. 1A is a schematic block diagram illustrating a conventional FSK modulator circuit incorporating a VCO circuit;

FIG. 1B is a detailed circuit diagram of the conventional FSK modulator circuit;

FIGS. 2A and 2B are timing charts illustrating waveforms of the bitstream signal and the corresponding FSK-modulated signal;

FIG. 3 is a block diagram illustrating an exemplary structure of a binary FSK-modulator circuit in a first embodiment of the present invention;

FIG. 4 is a diagram illustrating an exemplary change in the phase of the FSK-modulated signal;

FIG. 5 is a diagram for indicating signal mapping in I-Q space, which is implemented in a signal mapping circuit of the FSK-modulator circuit generating circuit shown in FIG. 3;

FIG. 6 is a table for representing an association of actual I/Q channel projections with I/Q data generated in the FSK modulator circuit shown in FIG. 3;

FIG. 7 is shows a waveform diagram illustrating an exemplary waveform of an input bitstream;

FIGS. 8A to 8C are diagram illustrating waveforms of an I-channel signal, a Q-channel signal, and an FSK-modulated signal for the input bitstream signal shown in FIG. 7;

FIG. 9 is a schematic block diagram for illustrating a preferred structure of the binary FSK modulator circuit of the first embodiment;

FIG. 10 is a schematic block diagram illustrating an exemplary structure of the signal mapping circuit used in the binary FSK-modulator circuit illustrated in FIG. 9;

FIG. 11 is a table for illustrating a association of barrel codes with the signal points and the values of I data, inverted I data, Q data, and inverted Q data; and

FIG. 12 is a schematic block diagram illustrating an exemplary structure of a binary FSK-modulator circuit in a second embodiment of the present invention.

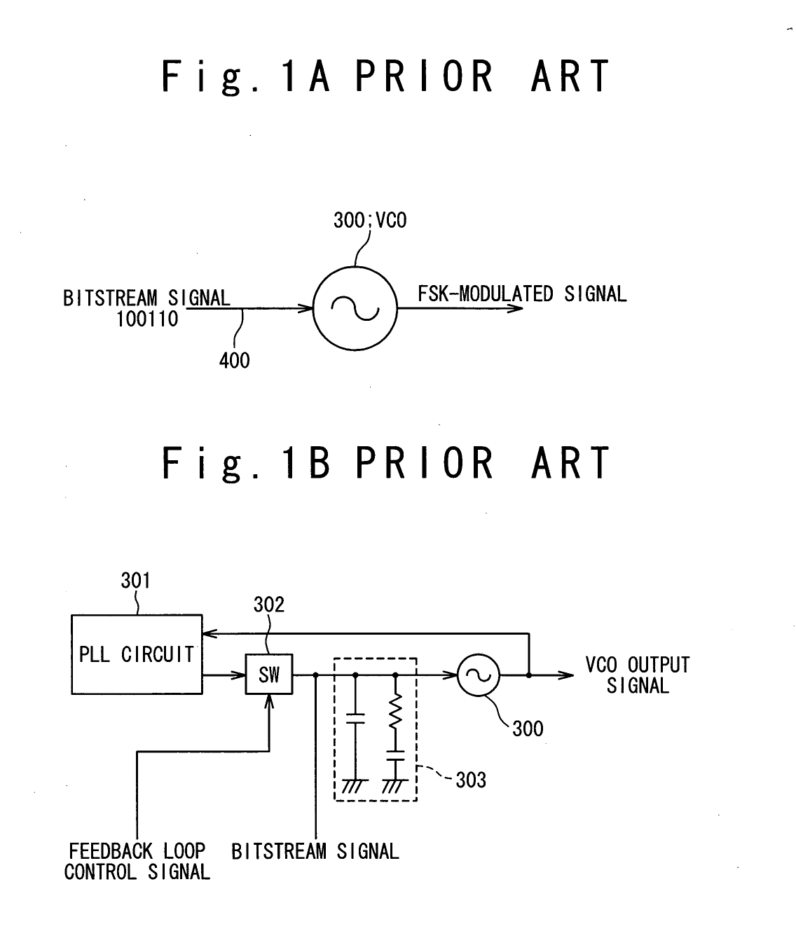

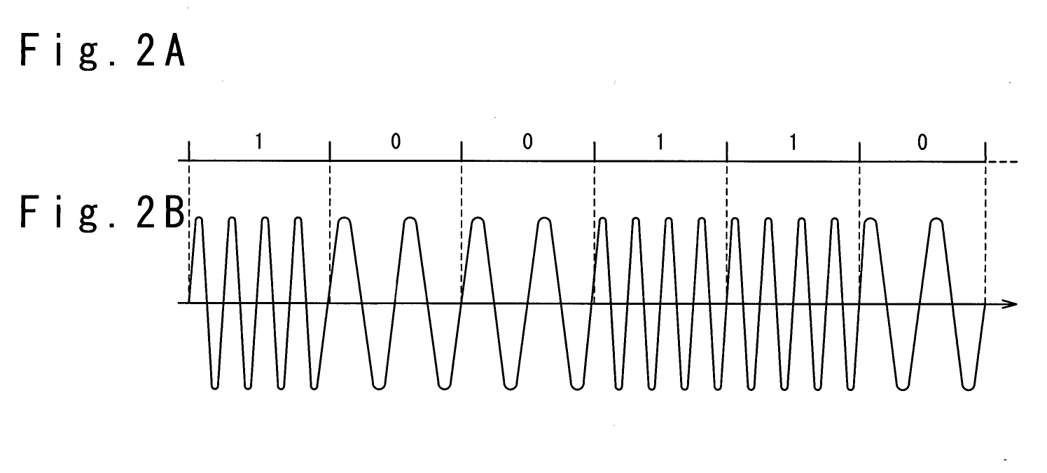

### DESCRIPTION OF THE PREFERRED EMBODIMENTS

Referring now to drawing, preferred embodiments of the present invention will be described below in detail.

First Embodiment

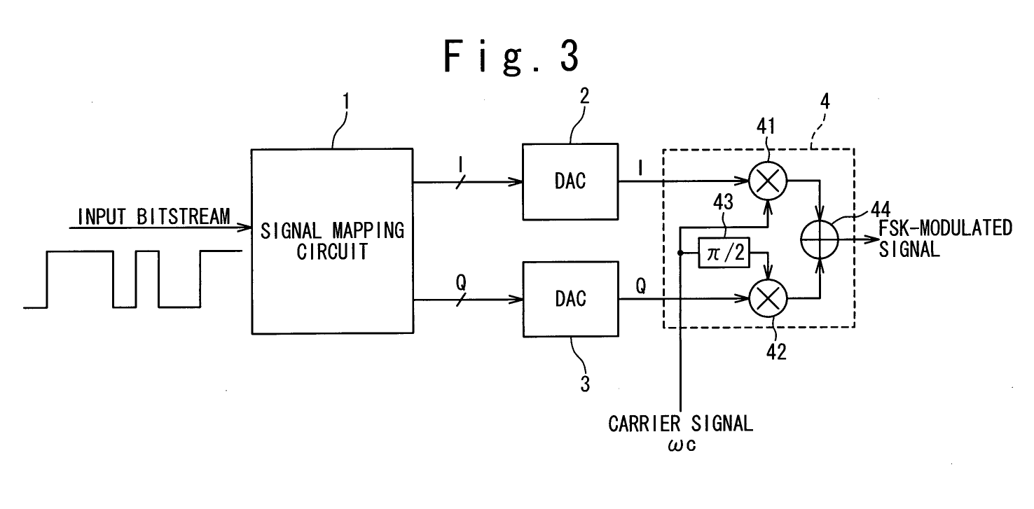

In a first embodiment of the present invention, as shown in FIG. 3, a binary FSK modulator circuit is composed of a signal mapping circuit 1, a pair of D/A converters 2 and 3, and a quadrature modulator 4.

The signal mapping circuit 1 implements signal mapping of an input bitstream to develop a set of I data and Q data, which are representative of I and Q channel projections of an resultant binary FSK-modulated signal in the I-Q space, respectively.

The D/A converters 2 and 3 converts the I data and Q data into an I-channel signal and a Q-channel signal, respectively. It should be noted that the I and Q signals are both analog signals.

The quadrature modulator 4 implements quadrature modulation of the I-channel signal and the Q-channel signal on a carrier signal, and thereby develops the binary FSK-modulated signal. In this embodiment, the quadrature modulator 4 is composed of multipliers 41 and 42, an adder 44, and a π/2 phase shifter 43. In the quadrature modulator 4, the binary FSK-modulated signal is generated from the I-channel signal and the Q-channel signal as described below: the multiplier 41 multiplies the I-channel signal by a carrier signal ω_{c}, while the multiplier 42 multiplies the Q-channel signal with the carrier signal ω_{c} delayed by 90 degrees by the π/2 phase shifter 43. The adder 44 adds the outputs of the multipliers 41 and 42, and thereby develops the binary FSK-modulated signal on the output.

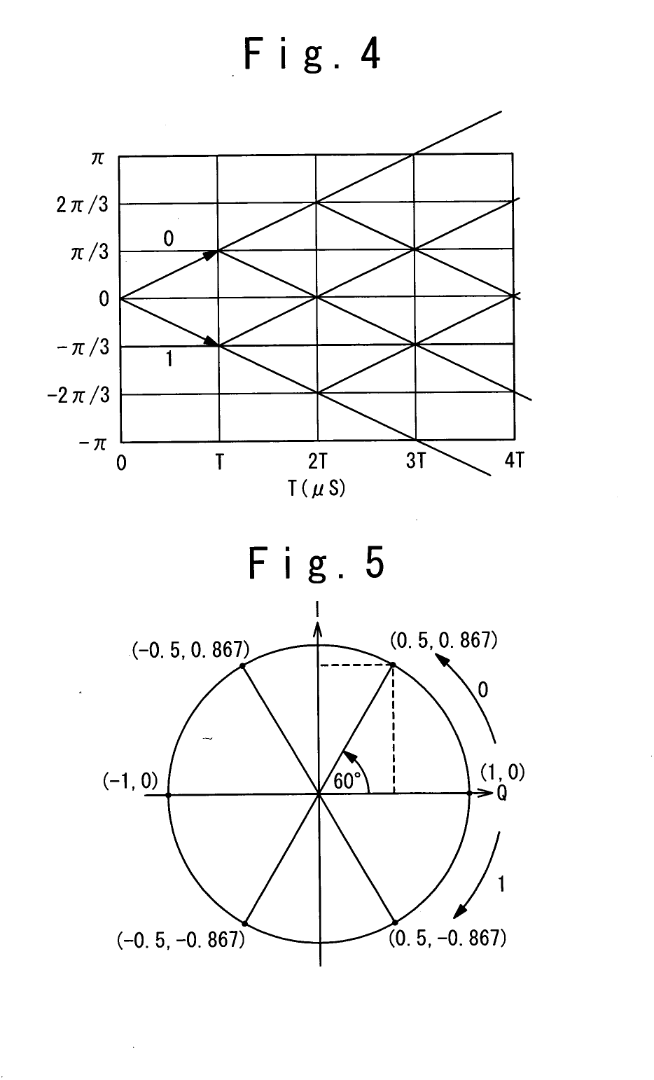

As illustrated in FIG. 4, the FSK-modulation involves smoothly rotating the phase φ(t) of the carrier signal ω_{c} at a constant rate in either a clock wise or anticlockwise direction in response to the input bitstream. The rate of the phase change represents the offset in the frequency “ω(t).” That is to say, the frequency offset “ω(t)” is given as follows:
ω(t)=dφ(t)/dt. (1)

As a consequence, the FSK-modulated signal exhibits the frequency offset of “+Δf” or “−Δf” in response to the value of each binary data bit of the input bitstream. The rate of the phase change (that is, the frequency offset) is switched between +bπ/T and −bπ/T for each bit of the input bitstream, where T is the bit period over which each bit of the input bitstream is inputted. The coefficient b, which is defined as being 2·Δf·T, is referred to as a modulation index, which is specific to the FSK modulation system.

FIG. 4 graphically represents an exemplary change in the phase of the FSK-modulated signal with under conditions that the modulation index b is ⅓ (=0.333 . . . ), and the bit period T is 1 (μs). The phase of the FSK-modulated signal is advanced at the rate of π/3 per bit period T, when the input bitstream takes on the value of “0”. For the value of “1”, on the other hand, the phase of the FSK-modulated signal is delayed at the rate of π/3 per bit period T.

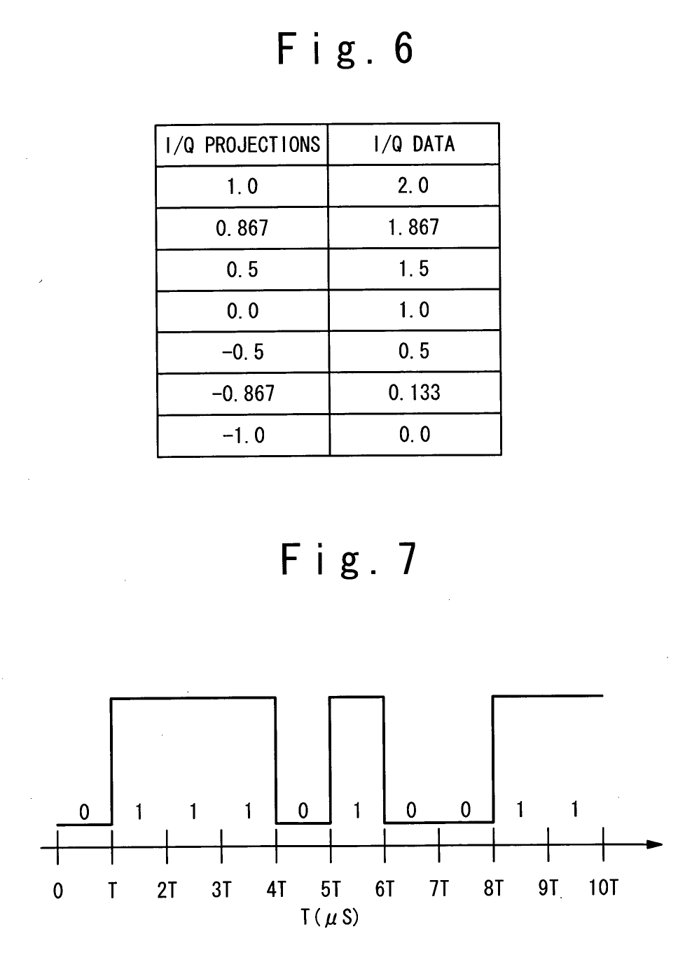

FIG. 5 indicates the phase change of the FSK-modulated signal in the normalized I-Q space. When a data bit of the input bitstream takes on the value of “0”, the phase of the FSK-modulated signal is smoothly rotated in the clockwise direction at the rate of π/3 (=60 degrees) per bit period T. This results in that the I and Q channel projections of the FSK-modulated signal is changed from an initial value (1, 0) to (0.5, 0.867) at the end of the data bit. When a data bit of the input bitstream takes on the value of “1”, on the other hand, the phase of the FSK-modulated signal is smoothly rotated in the counterclockwise direction at the rate of π/3 (=60 degrees) per bit period T. This results in that the I and Q channel projections of the FSK-modulated signal is changed from the initial value (1, 0) to (0.5, −0.867) at the end of the data bit.

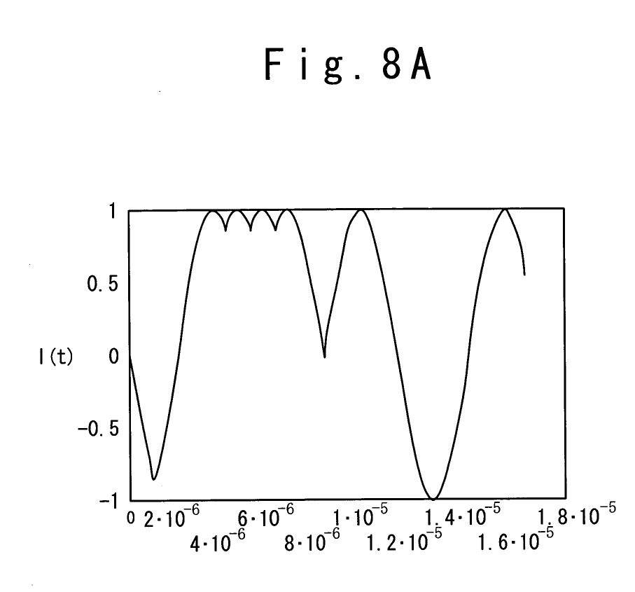

In this way, the signal mapping circuit 1 outputs the set of the I data and Q data representative of the normalized I and Q channel projections, in response to the input bitstream. In a preferred hardware implementation within an actual LSI (Large-Scale Integrated circuit), as illustrated in FIG. 6, the I data and Q data are developed so that the I data and Q data take on positive values associated with the normalized I and Q channel projections, which may be negative values. This effectively avoids using negative voltages within the LSI.

The I data and Q data, which are developed in the above-described manner, are transmitted to the D/A converters 2 and 3, in the form of digital signals.

The D/A converters 2 and 3 implements D/A conversion on the I data and Q data to develop the I-channel signal and the Q-channel signal, respectively. The signal levels of the I-channel signal and the Q-channel signal are represented by the following equations:

$$\begin{matrix}I ( t ) = {A}_{I} sin [ \frac{π}{3 T} t + \frac{π}{3} φ ( t ) + π ] , & ( 2 ) \\ Q ( t ) = {A}_{Q} cos [ \frac{π}{3 T} t + \frac{π}{3} φ ( t ) + π ] , & ( 3 )\end{matrix}$$

where I(t) and Q(t) are the signal levels of the I-channel and Q-channel signals, respectively, and quantities A_{I} and A_{Q} are amplitudes of the I-channel and Q-channel signals, respectively.

The I-channel and Q-channel signals are modulated on a carrier signal by the quadrature modulator 4 to develop the FSK-modulated signal. The signal level “V₀(t)” of the FSK-modulated signal is represented as follows:

$$\begin{matrix}{V}_{0} ( t ) = {V}_{0 I} ( t ) + {V}_{0 Q} ( t ) , \\ = {kA}_{I} sin [ \frac{π}{3 T} t + \frac{π}{3} φ ( t ) + π ] \times {\sum }_{n = 1}^{∞} {A}_{n} cos n {ω}_{c} t + \\ {kA}_{Q} cos [ \frac{π}{3 T} t + \frac{π}{3} φ ( t ) + π ] {\times \sum }_{n = 1}^{∞} {A}_{n} sin n {ω}_{c} t , \\ = kA {\sum }_{n = 1}^{∞} sin [ \frac{π}{3 T} t + \frac{π}{3} φ ( t ) + π + n {ω}_{c} t ] ,\end{matrix} \qquad ( 4 )$$

where V_{0I}(t) and V_{0Q}(t) are an I-channel component and a Q-channel component, respectively, k is the gain of the quadrature modulator, and finally ω_{c} is an angular velocity of the carrier signal. In this embodiment, the amplitude A_{I} of the I-channel signal is identical to the amplitude A_{Q} of the Q-channel signal. In the equation (4), the amplitudes of the I-channel and Q-channel signals are denoted by A (=A_{I}=A_{Q}).

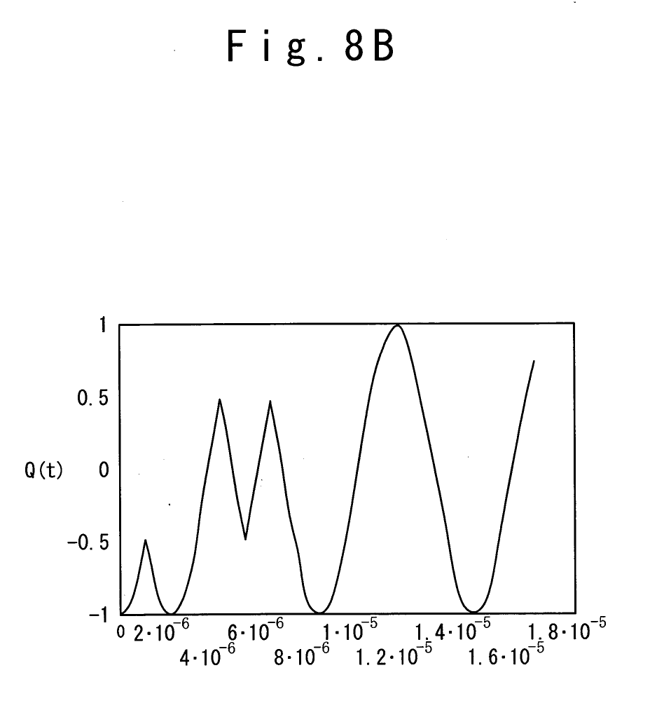

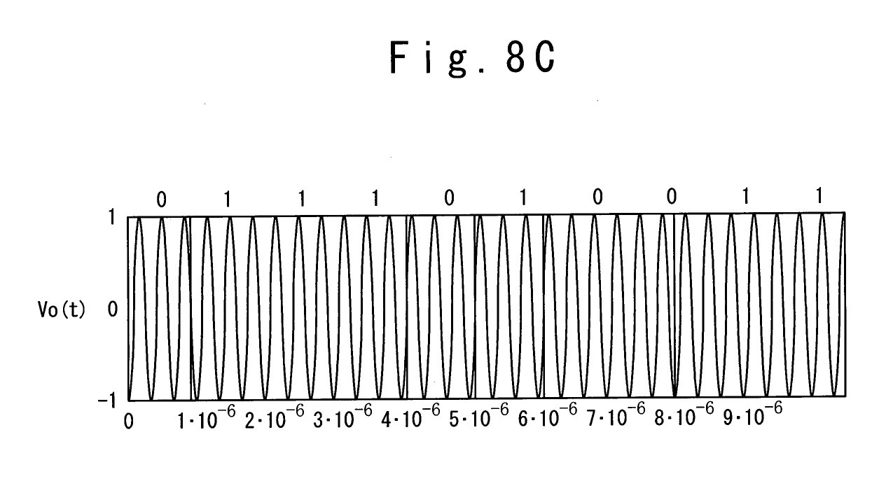

When the input bitstream is “0111010011” with the bit period T=1 (μs) as shown in FIG. 7, for example, the I-channel signal, the Q-channel signal and the resultant FSK-modulated signal exhibit waveforms illustrated in FIGS. 8A to 8C, respectively, with an assumption that the frequency of the carrier signal is 3 MHz, and the modulation index “b” is ⅓ (=0.333 . . . ).

As described above, the operation of the binary FSK-modulator circuit in this embodiment eliminates the need for controlling the oscillating frequency of a VCO. This effectively achieves stabilization of the center frequency and the modulation index of the resultant FSK-modulated signal.

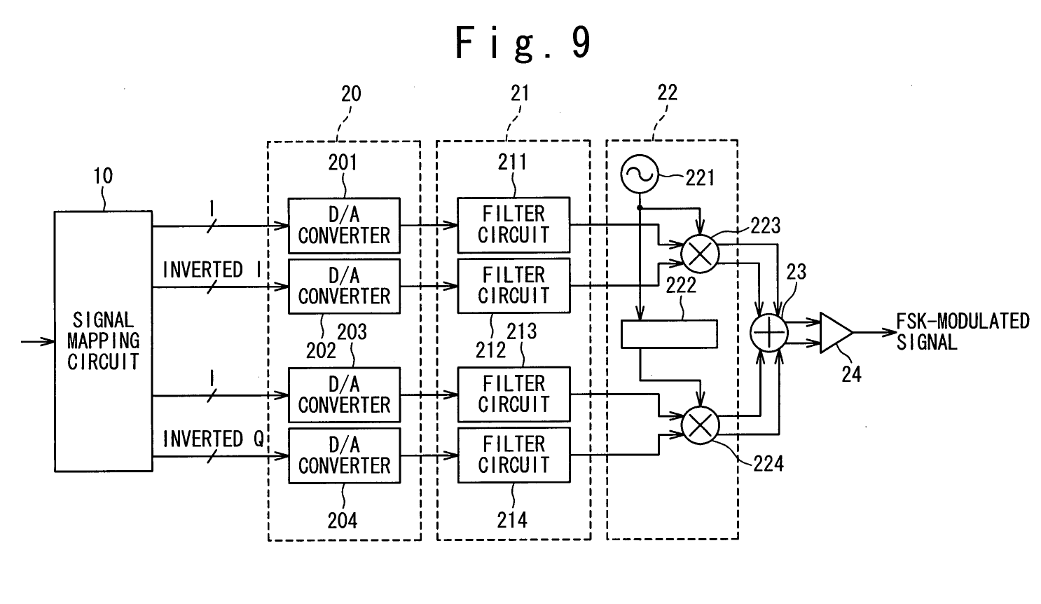

FIG. 9 illustrates another preferred structure of the binary FSK-modulator circuit. The binary FSK-modulator circuit shown in FIG. 9 is composed of a signal mapping circuit 10, a D/A converting unit 20, a filter unit 21, a frequency converting unit 22, an adder circuit 23, and a power amplifier 24.

The signal mapping circuit 10 performs mapping of the input bitstream in the I-Q space to develop a set of I-Q coordinate data: I data, inverted I data, Q data, and inverted Q data. The inverted I and Q data are representative of the I and Q projections of the signal point rotated by 180 degrees from the signal point associated with the I data and Q data. The D/A converting unit 20 includes four D/A converters 201, 202, 203, and 204. The D/A converters 201, 202, 203, 204 implement D/A-conversion on the I data, the inverted I data, the Q data, the inverted Q data to develop an I-channel signal, an inverted I-channel signal, a Q-channel signal, and an inverted Q-channel signal, which are all analog signals. The filter unit 21 includes filter circuits 211, 212, 213, and 214. The filter circuits 211, 212, 213, and 214 provides frequency band filtering for the I-channel signal, the inverted I-channel signal, the Q-channel signal, and the inverted Q-channel signal.

The frequency converting unit 22 includes an oscillator circuit 221, a phase delay circuit 222, and a pair of frequency converting circuits 223 and 224. The oscillator circuit 221 produces a carrier signal. The phase delay circuit 222 provides a delay of 90 degrees for the carrier signal. The frequency converting circuit 223 multiplies the I-channel signal received from the filter circuit 211 by the carrier signal, and also multiplies the inverted I-channel signal received from the filter circuit 212 by the carrier signal. Correspondingly, the frequency converting circuit 224 multiplies the Q-channel signal received from the filter circuit 213 by the 90-degree delayed carrier signal, and also multiplies the inverted Q-channel signal received from the filter circuit 214 by the 90-degree delayed carrier signal.

The adder circuit 23 adds the outputs of the frequency converting circuit 223 to the associated outputs of the frequency converting circuit 224 to thereby produce a pair of quadrature-modulated signals. The power amplifier circuit 24 provides power amplification for the quadrature-modulated signals to output the resultant FSK-modulated signal.

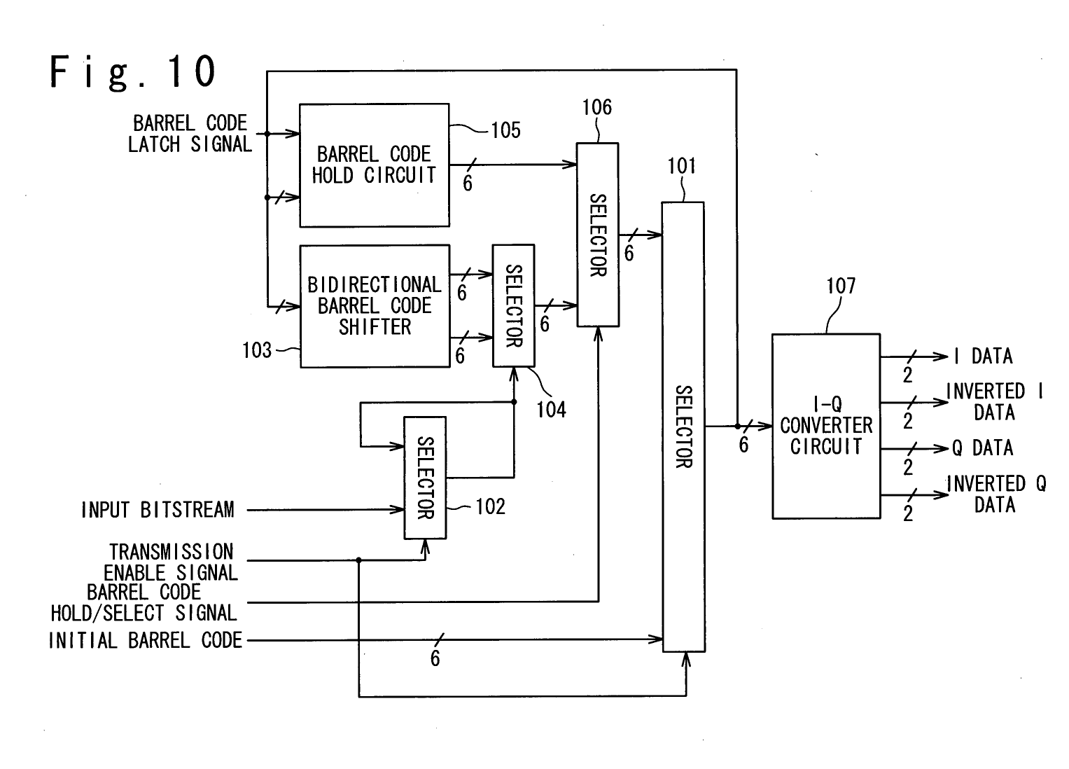

FIG. 10 illustrates an exemplary structure of the signal mapping circuit 10. In one embodiment, the signal mapping circuit 10 is composed of selectors 101 and 102, bidirectional barrel code shifter 103, a selector 104, a barrel code hold circuit 105, a selector 106, and an I-Q converter circuit 107.

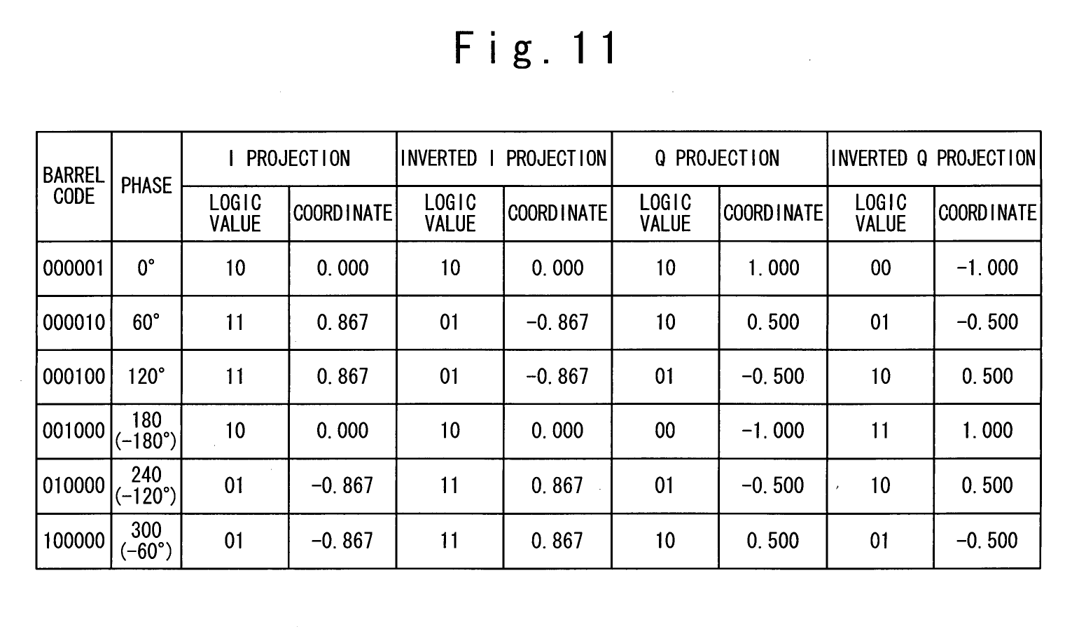

With reference to FIG. 11, a set of 6-bit barrel codes that are each associated with six signal points defined along the unit circle at intervals of 60 degrees are used for developing the I data, inverted I data, the Q data, and the inverted Q-data within the signal mapping circuit 10. It should be noted that the rate of change of the phase is π/3 per pit period, and therefore the phase of the FSK-modulated signal at the end of each data bit is selected out of the six allowable phases. Only one data bit is set “1” within the 6-bit barrel codes; the remaining bits are all set “0”. The digit of the “1” data bit within the barrel codes represents the phase of the resultant FSK-modulated signal.

Referring back to FIG. 10, the signal mapping circuit 10 is designed to select one of the 6-bit barrel codes in response to each data bit of the input bitstream, and to determine the I data, inverted I data, the Q data, and the inverted Q-data on the basis of the selected barrel code.

More specifically, the selectors 101 and 102, the bidirectional barrel code shifter 103, the selector 104, the barrel code hold circuit 105, and the selector 106 are used for selecting the 6-bit barrel codes.

The selector 102 selects one of the previous data bit or the present data bit of the input bitstream in response to a transmission enable signal.

The bidirectional barrel code shifter 103 is designed to develop two barrel codes through implementing cyclic left-shift and right-shift operations on the previously selected barrel code. When the previously selected barrel code is “000001”, the bidirectional barrel code shifter 103 outputs a pair of barrel codes having the values of “000010” and “100000”, respectively.

The selector 104 selects one of the two barrel codes received from the bidirectional barrel code shifter 103 in response to the output of the selector 102.

The barrel code hold circuit 105 latches the previously selected barrel code in response to a barrel code latch signal, and outputs the latched barrel code to the selector 106.

The selector 106 selects one of the outputs of the selector 104 and the barrel code hold circuit 105 in response to a barrel code hold/select signal.

The selector 101 selects one out of the output of the selector 106 and an initial barrel code that is representative of an initial set of I and Q channel projections, in response to the transmission enable signal. The finally selected barrel code is developed on the output of the selector 101.

The I-Q converter circuit 107 is responsive to the barrel code received from the selector 101 to develop the I data, inverted I data, the Q data, and the inverted Q-data. FIG. 11 illustrates an exemplary association of the selected barrel code with the I data, inverted I data, the Q data, and the inverted Q data to be generated. The I data, the inverted I data, the Q data, and the inverted Q-data are each 2-bit data representative of I and Q channel projections in I-Q space. When the selected barrel code is “000001”, for instance, the I-Q converter circuit 107 sets the I data to “10”, the inverted I data to “10”, the Q data to “11”, and the inverted Q data to “00”.

Referring now to FIG. 9 to FIG. 11, a description is made of operations of the binary FSK-modulator circuit having the above-explained arrangement.

In FSK-modulation of the input bitstream, composed of a series of data bits of “0” or “1”, the I and Q channel projections of the FSK-modulated signal (that is, the phase of the FSK-modulated signal) is rotated along the unit circle in response to the value of each bit.

In this embodiment, the signal point specified by the I and Q channel projections are rotated by 60 degrees in the counterclockwise direction for the data bit of “0”, while being rotated by 60 degrees in the clockwise direction for the data bit of “1”.

More specifically, the signal mapping circuit 10 selects one of the given 6-bit barrel codes in response to each data bit of the input bitstream, and determines the values of I and Q data (and the inverted I and Q data) for each data bit on the basis of the selected barrel code.

When the input bitstream, composed of N data bits (N being an integer more than one), is inputted to the signal mapping circuit 10 at a constant rate, an FSK-modulated signal is developed in response to the input bitstream in the manner described in the following.

Initially, the transmission enable signal is deactivated, and the selector 101 selects the initial barrel code to provide for the I-Q converting circuit 107 in response to the deactivation of the transmission enable signal. The initial barrel code is allowed to be arbitrarily selected out of the six given barrel codes. It should be noted that any signal point is allowed at the initial state. The I-Q converting circuit 107 initially determines the I and Q data (and the inverted I and Q data) in response to the initial barrel code.

When the first data bit of the input bitstream is inputted to the signal mapping circuit 10, the transmission enable signal is activated, and the selector 102 selects the input bitstream in response to the activation of the transmission enable signal.

In the meantime, the bidirectional barrel code shifter 103 develops a pair of barrel codes: one is the barrel code generated through 1-bit cyclic left-shift operation of the initial barrel code, and the other is the barrel code generated through 1-bit cyclic right-shift operation of the initial barrel code.

The selector 104 selects one of the barrel codes received from the bidirectional barrel code shifter 103 in response to the value of the first data bit of the input bitstream; For the value of “0”, the selector 104 selects the barrel code generated by the left-shift operation, while selecting the barrel code generated by the right-shift operation for the value of “1”.

Concurrently, the selector 106 selects the output of the selector 104 in response to the barrel code hold/select signal, and the selector 101 selects the output of the selector 106 in response to the activation of the transmission enable signal.

This results in that the barrel code for the first data bit of the input bitstream, selected out of the six barrel codes given in FIG. 11, is developed on the output of the selector 101.

The I-Q converting circuit 107 determines the values of the I data, the inverted I data, the Q data, and the inverted Q data in response to the barrel code associated with the first data bit of the input bitstream.

In response to the I data, the inverted I data, the Q data, and the inverted Q data, the D/A converting unit 20 then develops the I-channel signal, the inverted I-channel signal, the Q-channel signal, and the inverted Q-channel signal, and the resultant FSK-modulated signal is developed on the output of the power amplifier 24 through quadrature modulation achieved by the filter unit 21, the frequency converting unit 22, the adder unit 23, and the power amplifier 24.

The same goes for the second data bit of the input bitstream. The bidirectional barrel code shifter 103 develops a barrel code through 1-bit cyclic left-shift operation of the barrel code associated with the first data bit, and another barrel code through 1-bit cyclic right-shift operation. The selector 104 selects one of the barrel codes received from the bidirectional barrel code shifter 103 in response to the value of the second data bit. The selected barrel code is transferred to the I-Q converting circuit 107 through the selector 106, and the selector 101. The I-Q converting circuit 107 determines the values of the I data, the inverted I data, the Q data, and the inverted Q data.

The same operation is repeated for the remaining data bits till The I-Q converting circuit 107 outputs the I data, the inverted I data, the Q data, and the inverted Q data for the N-th data bit.

After the FSK-modulated signal is developed for the N-th data bit, the selector 102 is switched to select the previously outputted data bit in response to the deactivation of the transmission enable signal, and this results in that the selector 102 continues to output the N-th data bit. Furthermore, the barrel code hold circuit 105, which latches the previously selected barrel code on the output of the selector 101, continues to output the barrel code associated with the N-th data bit.

The signal point of the FSK-modulated signal may be fixed or continuously rotated after the output of the N-th data bit. When the signal point of the FSK-modulated signal is fixed, the selector 106 is configured to select the output of the barrel code hold circuit 105. When the signal point of the FSK-modulated signal is continuously rotated, on the other hand, the selector 106 is configured to select the output of the selector 104. As thus described, the signal mapping circuit 10, illustrated in FIG. 10, is designed to selectively fix or continuously rotate the signal point of the FSK-modulated signal when the input bitstream is invalid.

Second Embodiment

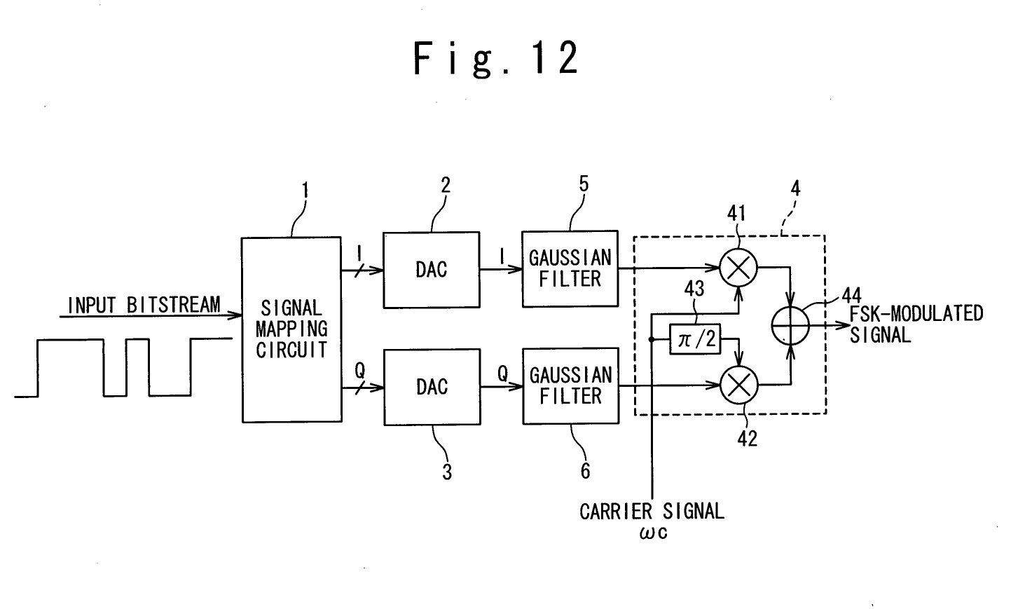

FIG. 12 is a schematic block diagram illustrating the structure of a binary FSK-modulator circuit in a second embodiment of the present invention. The structure of the binary FSK-modulator circuit in the second embodiment is similar to that of the binary FSK-modulator circuit in the first embodiment in the exception that the binary FSK-modulator circuit in this embodiment additionally includes a pair of Gaussian filters 5 and 6 connected to the outputs of the D/A converters 2 and 3.

The Gaussian filters 5 and 6 are designed to provide Gaussian smoothing for the I-channel signal and the Q-channel signal, which are analog signals received from the D/A converters 2 and 3 respectively. The Gaussian filters 5 and 6 outputs the band-limited I-channel signal and the band-limited Q-channel signal to the quadrature modulator circuit 4.

The Gaussian filters 5 and 6 are used to adapt the binary FSK-modulator circuit in this embodiment to the “Bluetooth™” standard, which is one of the major wireless communication standards. In the “Bluetooth” system, binary Gaussian FSK is used for wireless communications with the data rate 1 Mbps, the modulation index b=0.28-0.35 and BT=0.5, where the BT factor is defined as the product of the signal bandwidth B, bit period T (which is the inverse of the bit rate).

In the binary FSK-modulator circuit shown in FIG. 12, the I-channel signal and the Q-channel signal, generated by the D/A converters 2 and 3, are filtered by the Gaussian filters 5 and 6, respectively, and this allows the binary FSK-modulator circuit to generate a resultant binary GFSK-modulated signal with BT=0.5 on the output of the quadrature modulator circuit 4. The waveform of the binary GFSK-modulated signal is smoothed due to the use of the band limitation, compared to that illustrated in FIG. 8C.

As thus described, the use of the Gaussian filters 5 and 6 allows the binary FSK-modulator circuit in the second embodiment to develop a binary GFSK-modulated signal adapted to the “Bluetooth™” standard.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

Those skilled in the art would appreciate, for instance, that the structure of the signal mapping circuit employed in the binary FSK-modulator circuit of the present invention is not limited only to that illustrated in FIG. 10; other circuit arrangements may be used for the signal mapping circuit.

Additionally, LPFs (Low-Pass Filters) may be disposed between the outputs of the D/A converters 2 and 3 and the quadrature modulator 4, so as to eliminate high frequency components of the I-channel and Q-channel signals. This provides band filtering for the resultant FSK-modulated signal.

It should be also understood that the binary FSK-modulator circuit of the present invention may be applied not only to the FSK modulation and the GFSK modulation, but also to the MSK (Minimum Shift Keying) modulation, which is defined as the binary FSK modulation with the modulation index b=0.5, and the GMSK (Gaussian Minimum Shift Keying) modulation, which is defined as the MSK modulation with Gaussian filtering.

1. A binary FSK modulator circuit comprising:
a signal mapping circuit generating I data and Q data through signal mapping in response to an input bit stream, said I data being representative of an I channel projection and said Q data being representative of a Q channel projection;
a D/A converter circuit developing an I-channel signal and a Q-channel signal through implementing D/A conversion on said I data and said Q data, respectively; and
a quadrature modulator circuit developing a resultant FSK-modulated signal through quadrature modulation of said I-channel signal and said Q-channel signal on a carrier signal.

2. The binary FSK modulator circuit according to claim 1, further comprising:
a filter circuit filtering said I-channel signal and said Q-channel signal,
wherein said quadrature modulator circuit provides said quadrature modulation for said filtered I-channel and Q-channel signals.

3. The binary FSK modulator circuit according to claim 2, wherein said filter circuit provides Gaussian filtering for said I-channel signal and said Q-channel signal.

4. A method for generating a FSK-modulated signal comprising:
generating I data and Q data through signal mapping in response to an input bit stream, said I data being representative of an I channel projection and said Q data being representative of a Q channel projection;
developing an I-channel signal and a Q-channel signal through implementing D/A conversion on said I data and said Q data, respectively; and
developing a resultant FSK-modulated signal through quadrature modulation of said I-channel signal and said Q-channel signal on a carrier signal.

5. The method according to claim 4, further comprising:
filtering said I-channel signal and said Q-channel signal,
wherein said quadrature modulation is implemented on said filtered I-channel and Q-channel signals.

6. The method according to claim 5, wherein said filtering includes Gaussian filtering of said I-channel signal and said Q-channel signal.
